(19) United States
(12) Patent Application Publication
(10) Pub. No.: US 2025/0041932 A1
(43) Pub. Date: Feb. 6, 2025

(54) CONVEX CAMBERED NARROW-FACED COPPER PLATE OF CONTINUOUS CASTING CRYSTALLIZER AND METHOD FOR USING SAME

(71) Applicant: NORTHEASTERN UNIVERSITY, Shenyang (CN)

(72) Inventors: Miaoyong ZHU, Shenyang (CN); Zhaozhen CAI, Shenyang (CN)

(73) Assignee: NORTHEASTERN UNIVERSITY, Shenyang (CN)

(21) Appl. No.: 18/921,360

(22) Filed: Oct. 21, 2024

Related U.S. Application Data
(63) Continuation of application No. PCT/CN2023/120958, filed on Sep. 25, 2023.

(30) Foreign Application Priority Data
Oct. 27, 2022 (CN) 202211329292.4

(51) Int. Cl. B22D 11/059; B22D 11/043; B22D 11/055

(52) U.S. Cl. CPC B22D 11/059; B22D 11/043; B22D 11/055

(57) ABSTRACT

The present application discloses a convex lens-shaped narrow face copper plate for continuous casting molds and its utilization method. The narrow face copper plate includes a first hot face and a second hot face. A first connecting line being provided at a joint of the first hot face and the second hot face, and two such first connecting lines being provided. A cross section of the first hot face is a convex arc, and the first hot face extends from an top of the narrow face copper plate to a bottom of the narrow face copper plate, and a height of the first hot face protruding relative to a plane where the two first connecting lines are located gradually decreases from the top of the narrow face copper plate to the bottom of the narrow face copper plate.

### CROSS-REFERENCE TO RELATED APPLICATIONS

This application claims the priority of the Chinese Patent Application No. 202211329292.4, titled “CONVEX CAMBERED NARROW-FACED COPPER PLATE OF CONTINUOUS CASTING CRYSTALLIZER AND METHOD FOR USING SAME”, filed on Oct. 27, 2022 with the China National Intellectual Property Administration, which is incorporated herein by reference in its entirety.

### TECHNICAL FIELD

The present application relates to the field of crystallizer continuous casting, and in particular to a convex cambered narrow-faced copper plate of a continuous casting crystallizer and a method for using the same.

### BACKGROUND

Continuous casting slab is a main base material for preparing high-performance medium and heavy plates. In practical slab continuous casting production, high-temperature molten steel solidifies in a crystallizer consisting of two water-cooled wide-faced copper plates with a cooling channel structure on the back and two water-cooled narrow-faced copper plates with a cooling channel structure on the back, thus forming a solidified blank shell with a certain shape and excellent surface quality, and then gradually and completely solidifies in a secondary cooling casting flow with downward drawing of a blank to form a casting blank with qualified quality, shape and size.

Narrow-faced shape of the continuous casting slab is an important factor affecting an evolution of edge morphology of intermediate slab during plate rolling. In the practical rolling process of medium/wide plate, a narrow face of a planar or nearly planar slab gradually changes from planar shape to double stranded shape to single stranded shape. In this process, the narrow face of intermediate blank gradually turns up and down to an edge of a steel plate. Limited by the difficulty of controlling the edge of the intermediate blank at high temperature in the current rolling process of the medium/wide plate, the narrow face of the intermediate blank is easy to form a “wire drawing” shape defect, which leads to the formation of a fine linear crack defect, and then the narrow face of the intermediate blank turns up and down to the edge of the steel plate to form a steel plate edge crack defect. If the narrow face of the slab produced in the continuous casting process is bulging, it will further aggravate the width of the narrow face of the intermediate slab turning to the edge surface of the steel plate, and further deteriorate the edge quality of the steel plate. Strictly controlling the bulging of the narrow face of the continuous casting slab, especially preparing the narrow face of the continuous casting slab into a concave structure with a large arc surface is a key to reduce the significant width edge crack defects during the rolling process of the wide and thick plate.

A patent for utility model with the patent number of 201520673254.X and a patent for the invention with the patent number of 201610796688.8 both disclose a method for manufacturing a slab with a narrow-faced concave structure by using a crystallizer copper plate having a bump structure in a transverse middle part of a narrow-faced working face. The narrow-faced copper plate of the crystallizer designed by these two patents has an arc surface with a radius of 150 mm to 300 mm and a protrusion height of 5 mm to 12 mm in the transverse middle part of the working face, and the convex arc surface transitions to basic surfaces on both sides of the copper plate edge through a transition surface tangent to it. By adopting the narrow-faced copper plate of the crystallizer with this structure, a narrow-faced concave blank with a right-angle structure can be prepared, thus to some extent, the significant width edge crack defects formed in the rolling process of the wide and thick plates can be reduced. However, in order to realize a smooth transition between the convex arc surface at the transverse middle part and the basic surfaces at the two sides of the narrow-faced copper plate, it is necessary to design a wide transition region, so that the width of the arc convex surface at the transverse middle part of the narrow-faced copper plate of the crystallizer is very small, which leads to an extremely concentrated amount of the arc surface convex variation at the transverse middle part of the narrow-faced copper plate, that is, a rapid change of the convex structure, which will lead to the rapid change of the concave structure of the narrow-faced slab produced by the crystallizer, and it is easy for the narrow-faced slab to form a nearly “triangular” concave structure blank. For wide and thick plate rolling, significant double-strand shape defects are easily formed at the edge of the intermediate slab in the rolling process of the slab with this shape. Especially when an aspect ratio is large, it is easy to cause large-scale folding defects at the edge of the steel plate.

Therefore, it is necessary to design a new type of narrow-faced copper plate, and the width of the arc convex surface in the transverse middle part of the new type narrow-faced copper plate needs to be wide enough to avoid that the arc surface convex variation is too large to form a nearly “triangular” concave structure on the narrow face of the slab.

### SUMMARY

In view of this, the present application provides a convex cambered narrow-faced copper plate of a continuous casting crystallizer and a method for using the same.

Specifically, it includes the following technical solutions.

On the one hand, a convex cambered narrow-faced copper plate of a continuous casting crystallizer is provided, which includes a working face, where the working face includes:
a first working face and a second working face;
where two second working faces are provided, one of which is arranged at one side of the first working face and the other of which is arranged at the other side of the first working face, and the two second working faces are arranged oppositely;
the first working face is connected to each of the two second working faces, with a first connecting line being provided at a joint of the first working face and the second working face, and two first connecting lines being provided; and
a cross section of the first working face is a convex arc, and the first working face extends from an upper opening of the narrow-faced copper plate to a lower opening of the narrow-faced copper plate, and a height of the first working face protruding relative to a plane where the two first connecting lines are located gradually decreases from the upper opening of the narrow-faced copper plate to the lower opening of the narrow-faced copper plate.

Optionally, a plane where the upper opening of the narrow-faced copper plate is located is parallel to a plane where the lower opening of the narrow-faced copper plate is located;
a maximum vertical distance between the first working face in the plane where the upper opening of the narrow-faced copper plate is located and the plane where the two first connecting lines are located is a first length of the upper opening;
a maximum vertical distance between the first working face in the plane where the lower opening of the narrow-faced copper plate is located and the plane where the two first connecting lines are located is a first length of the lower opening; and
a vertical distance between the plane where the upper opening of the narrow-faced copper plate is located and the plane where the lower opening of the narrow-faced copper plate is located is ranged from 780 mm to 1200 mm, and a difference between the first length of the upper opening and the first length of the lower opening is from 0.2 mm to 4 mm.

Optionally, a width of the upper opening of the narrow-faced copper plate is greater than a width of the lower opening of the narrow-faced copper plate.

Optionally, the second working face extends from the upper opening of the narrow-faced copper plate to the lower opening of the narrow-faced copper plate, and a distance between an outer edge of the second working face and the first connecting line remains unchanged from the upper opening of the narrow-faced copper plate to the lower opening of the narrow-faced copper plate.

Optionally, the second working face includes an upper opening side working face and a lower opening side working face;
the upper opening side working face is connected to the lower opening side working face, and the upper opening side working face and the lower opening side working face are sequentially arranged along a direction from the upper opening of the narrow-faced copper plate to the lower opening of the narrow-faced copper plate; and
the upper opening side working face is a flat surface, the lower opening side working face is an inclined surface, and the lower opening side working face is inclined in a direction opposite to a convex direction of the first working face.

Optionally, the narrow-faced copper plate includes a cooling surface, and the cooling surface includes a side plane which is arranged opposite to the second working face and is arranged in parallel to the upper working face;
the lower opening side working face includes a first vertex, which is located on a connecting line between the lower opening side working face and the lower opening of the narrow-faced copper plate, and is arranged away from the first connecting line; and
the vertical distance between the first vertex and the side plane is the shortest vertical distance between the lower opening side working face and the side plane.

Optionally, a distance of the upper opening side working face extending from the upper opening of the narrow-faced copper plate to the lower opening side working face is a second length; and
the second length accounts for 25% to 75% of the vertical distance between the plane where the upper opening of the narrow-faced copper plate is located and the plane where the lower opening of the narrow-faced copper plate is located.

Optionally, the narrow-faced copper plate includes a fastening hole, a first cooling channel and a second cooling channel;
the fastening holes are provided with a plurality of rows, and the plurality of rows of fastening holes are symmetrically arranged along a vertical central axis of the narrow-faced copper plate;
the first cooling channel and the second cooling channel are arranged between two adjacent rows of fastening holes, where two first cooling channels and a plurality of second cooling channels are provided, the two first cooling channels are arranged adjacent to the two rows of fastening holes respectively, and the plurality of second cooling channels are located between the two first cooling channels;
a bottom portion of the first cooling channel is closer to the first working face than a bottom portion of the adjacent second cooling channel; and
the bottom portions of the plurality of second cooling channels are located on a same arc surface.

Optionally, a cross section of the first working face in the plane where the upper opening side working face and the lower opening side working face intersect with each other is a reference convex arc; and
a convex arc of a cross section of a circular arc surface where the bottom portions of the plurality of second cooling channels are located are arranged in parallel to the reference convex arc.

On the other hand, a method for using the convex cambered narrow-faced copper plate of the continuous casting crystallizer is provided, which adopts the narrow-faced copper plate of the convex cambered continuous casting crystallizer described above to form the crystallizer; and
in a working process of the crystallizer, cooling water is introduced into the cooling channel of the narrow-faced copper plate, flow rate of the cooling water in the cooling channel of the narrow-faced copper plate is greater than or equal to 6 m/s, and temperature difference between an inlet and an outlet of the cooling channel of the narrow-faced copper plate ranges from 5 degrees to 9 degrees.

The technical solutions provided by the present application have at least the following beneficial effects.

The first working face according to the present application is provided as a convex cambered surface, and a direct connection between the first working face and the second working face enables the width of the first working face wide enough, and the convex variation of the first working face is small, so that the narrow face of the slab is prevented from forming a concave structure in a near triangular shape due to the large convex variation of the first working face, and the probability of forming significant width edge crack defects and significant double-strand shape defects in the rolling process of the continuous casting slab is reduced.

### BRIEF DESCRIPTION OF DRAWINGS

In order to explain the technical solution in the embodiments of the present application more clearly, drawings referred to for describing the embodiments will be briefly illustrated below. Apparently, the drawings in the following description show only some examples of the present application, and for those skilled in the art, other drawings may be obtained based on these drawings without any creative efforts.

FIG. 1 is a schematic view showing a mounting structure of a narrow-faced copper plate in a crystallizer according to an embodiment of the present application;

FIG. 2 is a schematic structural view of the narrow-faced copper plate according to an embodiment of the present application;

FIG. 3 is a schematic view showing a side structure of a lower opening side working face of the narrow-faced copper plate according to an embodiment of the present application;

FIG. 4 is a schematic structural view of a cooling surface of the narrow-faced copper plate according to an embodiment of the present application;

FIG. 5 is a schematic cross-sectional structural view of the narrow-faced copper plate at a joint of an upper opening side working face and a lower opening side working face according to an embodiment of the present application;

FIG. 6 is a schematic cross-sectional structural view of the narrow-faced copper plate at the joint of the upper opening side working face and the lower opening side working face according to another embodiment of the present application.

The reference numerals in the drawings are listed as follows:
100 narrow-faced copper plate; 200 wide-faced copper plate; 300 slab;
1 first working face; 2 upper opening side working face; 3 lower opening side working face; 4 upper opening of narrow-faced copper plate; 5 lower opening of narrow-faced copper plate; 6 cooling surface; 7 fastening hole; 8 first cooling channel; 9 second cooling channel; 10 inclined channel; 11 bottom portion; L₁ first connecting line; L₂ outer edge of lower opening side working face; L₃ reference convex arc; L₄ convex arc of cross section of arc surface where bottom portions of plurality of second cooling channels are located; l₁ first length of upper opening; l₂ second length; l₃ third length; l₄ fourth length; is fifth length; l₆ sixth length; l₇ seventh length; l₈ eighth length; l₉ ninth length; O₁ first endpoint; O₂ first vertex; θ₁ included angle between axis of inclined channel and upper opening side working face.

Through the above drawings, a specific embodiment of the present application has been shown, which will be described in more detail hereinafter. These drawings and descriptions are not intended to limit the scope of the concept of the present application in any way, but to explain the concept of the present application to those skilled in the art by referring to the specific embodiments.

### DETAILED DESCRIPTION OF THE EMBODIMENTS

Hereinafter, the technical solutions according to the embodiments of the present application will be clearly and completely described with reference to the drawings in the embodiment of the present application. Apparently, the described embodiments are only a part of the embodiments of the present application, rather than all of the embodiments. Based on the embodiments in the present application, all of other embodiments obtained by those skilled in the art without any creative work fall within the protection scope of the present application.

Before the embodiments of the present application is further described in detail, the directional terms involved in the embodiments of the present application, such as “upper”, “lower” and “side”, do not limit the protection scope of the present application.

In order to make the technical solutions and advantages of the present application more clear, the embodiment of the present application will be further described in detail with the attached drawings.

### Example 1

A convex cambered narrow-faced copper plate of a continuous casting crystallizer is described in this embodiment. The narrow-faced copper plate 100 includes a working face, and the working face includes a first working face 1 and a second working face, where two second working faces are provided, one of which is arranged at one side of the first working face 1, and the other of which is arranged at the other side of the first working face 1, and the two second working faces are arranged oppositely. The first working face 1 is connected to each of the two second working faces, with a first connecting line L₁ being provided at a joint of the first working face 1 and the second working face, and two first connecting lines L₁ being provided. A cross section of the first working face 1 is a convex arc. The first working face 1 extends from an upper opening 4 to a lower opening 5 of the narrow-faced copper plate. A height of the first working face 1 protruding relative to a plane where the two first connecting lines L₁ are located gradually decreases from the upper opening 4 to the lower opening 5 of the narrow-faced copper plate.

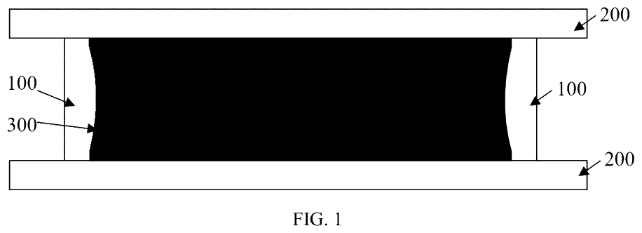

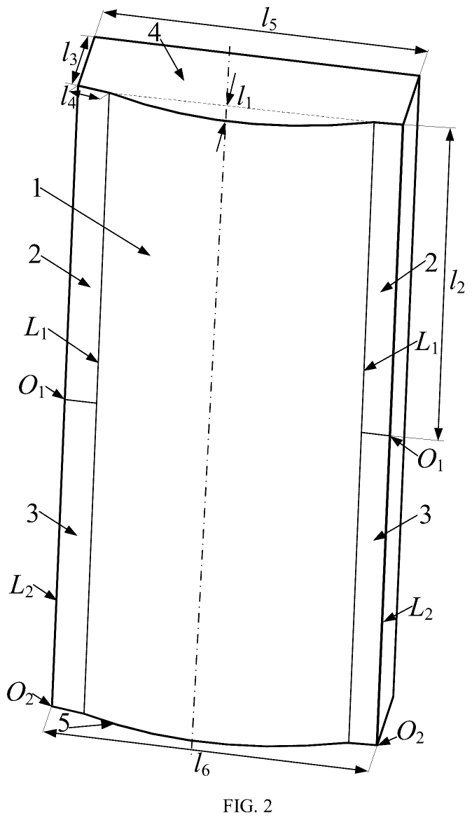

As shown in FIG. 1, the crystallizer includes two wide-faced copper plates 200 and two narrow-faced copper plates 100. In this embodiment, the crystallizer where the narrow-faced copper plates 100 are located is used for continuous casting to produce a narrow-faced concave slab 300 with a thickness of 175 mm to 650 mm. As shown in FIG. 2, the upper opening 4 of the narrow-faced copper plate is located at an upper end of the narrow-faced copper plate 100, and the lower opening 5 of the narrow-faced copper plate is located at a lower end of the narrow-faced copper plate 100. The working face is a contact side of the solidified shell. The first working face 1 is a convex cambered surface protruding in a direction toward an inner cavity of the crystallizer. It can be understood that the height of the first working face 1 protruding relative to the plane where the two first connecting lines L₁ are located refers to a distance that the first working face 1 extends in the direction toward the inner cavity of the crystallizer. The two second working faces are located on both sides of the first working face 1, and are symmetrically arranged along a vertical central axis of the first working face 1. It can be understood that the vertical central axes of the two narrow-faced copper plates 100 are coplanar. The first connecting line L₁ is formed at the joint of the first working face 1 and the second working face 1, and the two first connecting lines L₁ are formed between the two second working faces 1 and the first working face 1. The height of the first working face 1 protruding relative to the plane where the two first connecting lines L₁ are located gradually decreases from the upper opening 4 of the narrow-faced copper plate to the lower opening 5 of the narrow-faced copper plate.

In this embodiment, there is no transition surface between the first working face 1 and the two second working faces, and a direct connection between the first working face 1 and the second working face enables a width of the first working face 1 large enough. A convex variation of the first working face 1 is small, so that the slab 300 has a wide arc-shaped concave structure, which avoids a concave structure of the narrow face of the slab being nearly triangular when the convex variation of the first working face 1 is large, and reduces a probability of a formation of significant width edge crack defects and significant double-strand shape defects during a rolling process of the continuously cast slab.

At the same time, due to an arrangement of the second working face, the slab 300 has a right-angle structure, which ensures that temperature at a corner portion of the slab 300 in a secondary cooling casting flow will not be too low, so that transverse cracks in the corner portion of the slab 300 can be controlled during the continuous casting process. Furthermore, due to the height of the first working face 1 protruding relative to the plane where the two first connecting lines L1 are located gradually decreases from the upper opening 4 of the narrow-faced copper plate to the lower opening 5 of the narrow-faced copper plate, the crystallizer using the narrow-faced copper plate 100 can adopt a larger taper for continuous casting production, so that crystal grain at the corner portion of the solidified slab 300 is refined, thus reducing a generation of the transverse cracks in the corner portion of the slab 300, and also significantly reducing wear of the first working face 1 in an area near the lower opening 5 of the narrow-faced copper plate, thus prolonging the narrow-faced copper plate.

Optionally, the plane where the upper opening 4 of the narrow-faced copper plate is located is parallel to the plane where the lower opening 5 of the narrow-faced copper plate is located. The maximum vertical distance between the first working face 1 in the plane where the upper opening 4 of the narrow-faced copper plate is located and the plane where the two first connecting lines L₁ are located is the first length l₁ of the upper opening. The maximum vertical distance between the first working face 1 in the plane where the lower opening 5 of the narrow-faced copper plate is located and the plane where the two first connecting lines L₁ are located is the first length of the lower opening. The vertical distance between the plane where the upper opening 4 of the narrow-faced copper plate is located and the plane where the lower opening 5 of the narrow-faced copper plate is located ranges from 780 mm to 1200 mm, and the difference between the first length l₁ of the upper opening and the first length of the lower opening is from 0.2 mm to 4 mm.

Further, a height direction of the narrow-faced copper plate 100 is from the upper opening 4 to the lower opening 5 of the narrow-faced copper plate, and a highest point of the first working face 1 at each height is located on the vertical central axis of the narrow-faced copper plate 100. In this embodiment, the first length l₁ of the upper opening is from 8 mm to 40 mm, and the maximum vertical distance between the plane where the first working face 1 and the two first connecting lines L₁ are located at other heights decreases linearly from the upper opening 4 of the narrow-faced copper plate to the lower opening 5 of the narrow-faced copper plate until it decreases to the first length of the lower opening.

Further, as shown in FIG. 2, a width of the upper opening 4 of the narrow-faced copper plate is a fifth length l₅, which indicates a width direction of the narrow-faced copper plate 100, and a width of the lower opening 5 of the narrow-faced copper plate is a sixth length l₆. In this embodiment, the fifth length l₅ is 1 mm to 4 mm longer than the sixth length l₆, and the fifth length l₅ linearly decreases to the sixth length l₆ along the direction from the upper opening 4 of the narrow-faced copper plate to the lower opening 5 of the narrow-faced copper plate.

Optionally, as shown in FIG. 2, in this embodiment, the second working face extends from the upper opening 4 to the lower opening 5 of the narrow-faced copper plate, and the distance between the outer edge of the second working face and the first connecting line L₁ is a fourth length l₄, which remains unchanged from the upper opening 4 to the lower opening 5 of the narrow-faced copper plate. Based on a thickness of the slab 300 produced by the continuous casting, the fourth length l₄ is ranged from 10 mm to 50 mm. As shown in FIG. 1, the thickness of the slab 300 refers to the direction indicated by the distance between the two wide-faced copper plates 200.

Optionally, as shown in FIG. 2, the second working face includes an upper opening side working face 2 and a lower opening side working face 3, which are connected with each other, and are sequentially arranged along the direction from the upper opening 4 of the narrow-faced copper plate to the lower opening 5 of the narrow-faced copper plate. The upper opening side working face 2 is a flat surface, the lower opening side working face 3 is an inclined surface, and the lower opening side working face 3 is inclined in a direction opposite to a convex direction of the first working face 1. Further, the lower opening side working face 3 has four sides, including the outer edge L₂ of the lower opening side working face, the first connecting line L₁, the lower edge of the lower opening side working face and the upper edge of the lower opening side working face, where the lower edge of the lower opening side working face is an intersection line of the lower opening side working face 3 and the lower opening 5 of the narrow-faced copper plate, and the upper edge of the lower opening side working face is an intersection line of the lower opening side working face 3 and the upper opening side working face 2. The lower opening side working face 3 gradually inclines away from an extending face of the upper opening side working face 2 along a direction from the first connecting line L₁ to the outer edge L₂ of the lower opening side working face, while the lower opening side working face 3 gradually inclines away from the extending face of the upper opening side working face 2 along a direction from the upper edge of the lower opening side working face to the lower edge of the lower opening side working face.

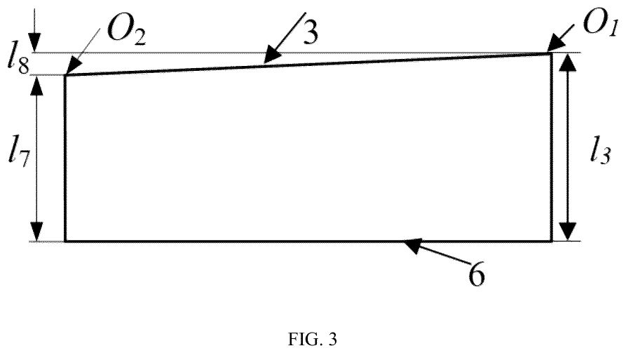

Further, as shown in FIG. 2 and FIG. 3, the narrow-faced copper plate 100 includes a cooling surface 6, which is arranged opposite to the working face, and a cooling channel is arranged on the cooling surface 6 for cooling the continuous casting slab 300. The cooling surface 6 includes a side plane which is arranged opposite to the second working face and parallel to the upper opening side working face 2. The lower opening side working face 3 includes a first vertex O₂, where the first vertex O₂ is located on the connecting line between the lower opening side working face 3 and the lower opening 5 of the narrow-faced copper plate, and the first vertex O₂ is located away from the first connecting line L₁. The vertical distance between the first vertex O₂ and the side plane is the shortest vertical distance between the lower opening side working face 3 and the side plane. It can be understood that the first vertex O₂ is the intersection of the lower edge of the lower opening side working face and the outer edge L₂ of the lower opening side working face. The vertical distance between the first vertex O₂ and the side plane is a seventh length l₇, the vertical distance between the upper opening side working face 2 and the side plane is a third length l₃, and the length difference between the third length l₃ and the seventh length 7 is an eighth length l₈. In this embodiment, the third length l₃ is ranged from 35 mm to 45 mm, and the eighth length l₈ is ranged from 0.25 mm to 4 mm. Further, a value of the eighth length l₈ generally should be greater than or equal to the difference between the first length l₁ of the upper opening and the first length of the lower opening.

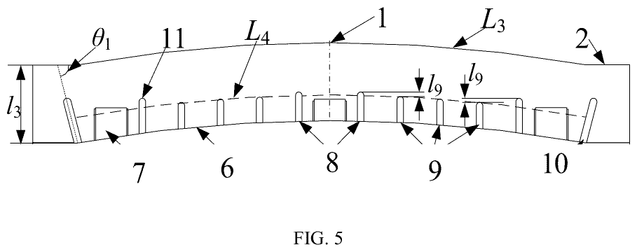

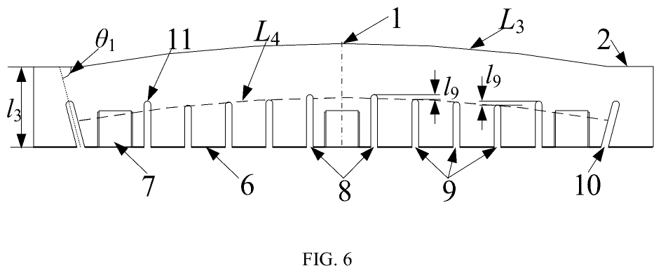

Further, as shown in FIG. 5, the cooling surface 6 includes two side planes and an arc-shaped surface in a middle part in an embodiment. As shown in FIG. 6, the cooling surface 6 includes two side planes and a plane in the middle part in another embodiment.

Further, it can be understood that in this embodiment, the upper opening side working face 2 has four sides, including the outer edge of the upper opening side working face, the first connecting line L₁, the lower edge of the upper opening side working face and the upper edge of the upper opening side working face, where the lower edge of the upper opening side working face is an intersection line of the lower opening side working face 3 and the upper opening side working face 2, the upper edge of the upper opening side working face is the intersection line of the upper opening side working face 2 and the upper opening 4 of the narrow-faced copper plate, the outer edge of the upper opening side working face is an edge arranged in parallel and opposite to the first connecting line L₁, and the outer edge of the upper opening side working face and the outer edge L₂ of the lower opening side working face are connected at a first end point O₁.

Further, it can be understood that the second working face includes an upper opening side working face 2 and a lower opening side working face 3, where the lower opening side working face 3 includes an outer edge L₂ of the lower opening side working face, the upper opening side working face 2 includes an outer edge of the upper opening side working face, and the outer edge of the upper opening side working face and the outer edge L₂ of the lower opening side working face are connected to form an outer edge of the second working face. The distance between the outer edge of the second working face and the first connecting line L₁ is a fourth length l₄, and the fourth length l₄ remains unchanged from the upper opening 4 of the narrow-faced copper plate to the lower opening 5 of the narrow-faced copper plate. It can be understood that the distance between the two first connecting lines L₁ in a width direction of the narrow-faced copper plate 100 decreases linearly from the upper opening 4 to the lower opening 5 of the narrow-faced copper plate, and the distance between the two first connecting lines L₁ in the plane of the upper opening 4 of the narrow-faced copper plate in the width direction of the narrow-faced copper plate 100 is 1 mm to 4 mm longer than the distance between two first connecting lines L₁ in the plane of the lower opening 5 of the narrow-faced copper plate along the width direction of the narrow-faced copper plate 100. The inclined lower opening side working face 3 reduces the solidification shrinkage compensation of the lower opening of the crystallizer to the slab 300, further reduces the abrasion of the slab 300 to the lower opening 5 of the narrow-faced copper plate when preparing the slab 300, and prolongs the service life of the narrow-faced slab 300.

Optionally, the distance from the upper opening side working face 2 to the lower opening side working face 3 of the narrow-faced copper plate is the second length l₂. The second length l₂ accounts for 25% to 75% of the vertical distance between the plane where the upper opening 4 of the narrow-faced copper plate is located and the plane where the lower opening 5 of the narrow-faced copper plate is located. In this embodiment, the vertical distance between the plane where the upper opening 4 of the narrow-faced copper plate is located and the plane where the lower opening 5 of the narrow-faced copper plate is located is ranged from 780 mm to 1200 mm, and the second length l₂ is generally 250 mm to 600 mm depending on the height of the crystallizer and the casting speed.

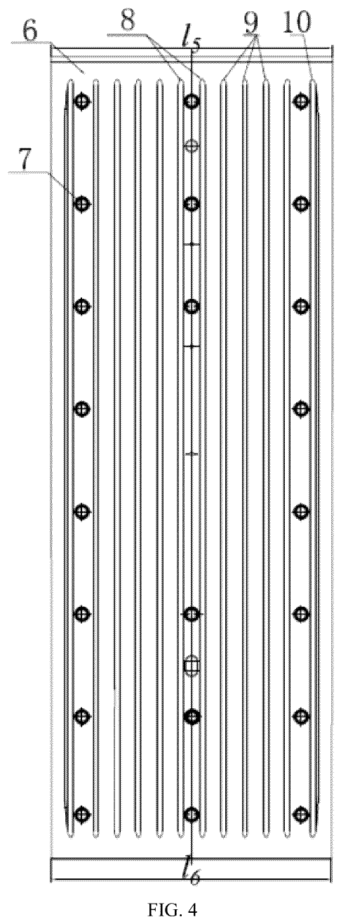

Optionally, as shown in FIG. 4, FIG. 5 and FIG. 6, the narrow-faced copper plate 100 includes a fastening hole 7, a first cooling channel 8 and a second cooling channel 9. A plurality of rows of fastening holes 7 are arranged symmetrically along the vertical central axis of the narrow-faced copper plate 100. The first cooling channel 8 and the second cooling channel 9 are arranged between two adjacent rows of fastening holes 7. There are two first cooling channels 8 and a plurality of second cooling channels 9, and both of them extend along the height direction of the narrow-faced copper plate 100. The two first cooling channels 8 are respectively arranged adjacent to the two rows of fastening holes 7, and the plurality of second cooling channels 9 are located between the two first cooling channels 8. The bottom portion of the first cooling channel 8 is closer to the first working face 1 than the bottom portion of the adjacent second cooling channel 9. The bottom portions of the plurality of second cooling channels 9 are located on the same arc surface.

Further, as shown in FIG. 4, the cooling surface 6 is provided with the fastening hole 7, a first cooling channel 8, a second cooling channel 9 and an inclined channel 10, where the fastening hole 7 is a bolt hole. In this embodiment, the width direction is the length extension direction of the fifth length 15. Generally, based on the thickness of the produced continuous casting slab, two to four rows of fastening holes 7 are distributed on the cooling surface 6 in the width direction for fixing the narrow-faced copper plate 100 to a stainless steel back plate of the crystallizer. The first cooling channel 8, the second cooling channel 9 and the inclined channel 10 are uniformly distributed along the width direction of the narrow-faced copper plate 100, and the widths of the first cooling channel 8, the second cooling channel 9 and the inclined channel 10 are the same. As shown in FIG. 5 and FIG. 6, the first cooling channel 8 and the second cooling channel 9 are vertically recessed in the direction of the plane where the two first connecting lines L₁ are located, and the inclined channel 10 is obliquely recessed in the middle direction of the second working face. In this embodiment, when the inclined channel 10 is inclined to the middle part of the second working face, an included angle between an axis of the inclined channel 10 and the upper opening side working face 2 is θ₁, which is generally 65 degrees to 80 degrees.

Further, as shown in FIG. 4, the two first cooling channels 8 and the plurality of second cooling channels 9 are arranged between the two adjacent rows of fastening holes 7. It can be understood that the two first cooling channels 8 and the plurality of second cooling channels 9 herein refer to the first cooling channels 8 and the second cooling channels 9 arranged between the two adjacent rows of fastening holes 7. Therefore, the whole cooling surface 6 is provided with a plurality of first cooling channels 8, a plurality of second cooling channels 9 and two inclined channels 10, where the plurality of first cooling channels 8, the plurality of second cooling channels 9 and the two inclined channels 10 are symmetrically arranged along the vertical central axis of the narrow-faced copper plate 100.

Further, as shown in FIG. 5 and FIG. 6, the first cooling channel 8, the second cooling channel 9 and the inclined channel 10 all have a bottom portion 11, and the bottom portion 11 has a semicircular structure.

Optionally, as shown in FIG. 5 and FIG. 6, a cross section of the first working face 1 located in the plane where the upper opening side working face 2 meets with the lower opening side working face 3 is a reference convex arc L₃. The convex arc L₄ of the cross section of the circular arc surface where the bottom portions 11 of the plurality of second cooling channels 9 are located and the reference convex arc L₃ are arranged in parallel to each other.

Further, the plane where the upper opening side working face 2 meets with the lower opening side working face 3 is the cross section of the narrow-faced copper plate 100 at a height where the first end point O₁ is located. The convex arc L₄ of the cross section of the circular surface where the bottom portions of the plurality of second cooling channels 9 are located is obtained by translating the reference convex arc L3 vertically to the cooling surface 6 by 20 mm to 30 mm.

Further, the vertical distance between the bottom portion of the second cooling channel 9 and the bottom portion of the first cooling channel 8 adjacent thereto is a ninth length l₉, which in this embodiment is 1 mm to 3 mm.

The structure and arrangement of the first cooling channel 8, the second cooling channel 9 and the inclined channel 10 in this embodiment ensure the uniform heat transfer of the narrow-faced copper plate 100 of the crystallizer in the width direction.

A crystallizer is further provided in this embodiment, which adopts the convex cambered narrow-faced copper plate 100 of the continuous casting crystallizer as described above. When two narrow-faced copper plates 100 are provided, the distance between the upper openings 4 of the two narrow-faced copper plates 100 is greater than the distance between the lower openings 5 of the two narrow-faced copper plates 100, so that the crystallizer has a structure of a wide upper portion and a narrow lower portion, with a certain reverse taper ranged from 1.05% to 1.35%.

A method for using the convex cambered narrow-faced copper plate 100 of the continuous casting crystallizer is further provided in this embodiment. During the operation of the crystallizer, cooling water is introduced into the cooling channel of the narrow-faced copper plate 100. The amount of the cooling water of the narrow-faced copper plate 100 may be varied based on the structure of the channel, the flow rate of the cooling water in the cooling channel of the narrow-faced copper plate 100 is greater than or equal to 6 m/s, and the temperature difference between the inlet and outlet of the cooling channel of the narrow-faced copper plate 100 is 5 degrees to 9 degrees.

It can be understood that the cooling channel of the narrow-faced copper plate 100 refers to the first cooling channel 8, the second cooling channel 9 and the inclined channel 10. The amount of the cooling water varies based on the tank structure. The flow rate of the cooling water in the cooling channel of the narrow-faced copper plate 100 is greater than or equal to 6 m/s, and the temperature difference between the inlet and outlet of the cooling channel is 5 degrees to 9 degrees.

By applying the narrow-faced copper plate 100 of this embodiment and arranging the first working face 1 and the second working face, a narrow-faced concave slab 300 with a right-angle structure can be prepared, which ensures that the width of edge cracks in the process of slab rolling/wide and thick plate is controlled within the range of 20 mm from the edge, and at the same time, it can also ensure that the corner temperature of the slab 300 in the solidification process in the secondary cooling casting flow is close to that of the conventional right-angle continuous casting slab 300, so that the slab 300 being highly prone to have corner cracks can be controlled. The transverse middle part of the narrow face of the slab 300 prepared by using the narrow-faced copper plate 100 in this embodiment is a wide circular arc concave structure, which eliminates the narrow face folding defect caused by the published sharp transition concave blank rolling. In this embodiment, the service life of the narrow-faced copper plate 100 is significantly prolonged due to the reduced wear at the lower opening 5 of the narrow-faced copper plate. Using the narrow-face copper plate 100 of this embodiment to continuously produce the slab 300 can ensure that the narrow face of the crystallizer can be continuously produced by using the large taper process.

### Example 2

A convex cambered narrow-faced copper plate 100 of a crystallizer for continuous casting of a slab 300 with a thickness of 300 mm has a height of 900 mm. A width of an upper opening 4 of the narrow-faced copper plate has a fifth length l₅ of 316 mm, a width of a lower opening 5 of the narrow-faced copper plate has a sixth length l₆ of 314 mm, and a length difference between the fifth length is and the sixth length l₆ is 2 mm. The width of the narrow-faced copper plate 100 gradually linearly decreases from the fifth length is to the sixth length l₆ from the upper opening 4 to the lower opening 5 of the narrow-faced copper plate, as shown in FIG. 2.

The narrow-faced copper plate 100 includes a working face on a side contacting with a solidified shell and a cooling surface 6 with a cooling channel opposite to the working face. The working face of the narrow-faced copper plate 100 is divided into the second working face on both sides and the first working face 1 in the middle part along the width direction. The connecting line between the second working faces on both sides and the first working face 1 in the middle part is the first connecting line L₁. The second working face is divided into an upper opening side working face 2 and a lower opening side working face 3 in the height direction of the narrow-faced copper plate 100, as shown in FIG. 2. The upper opening side working face 2 and the lower opening side working face 3 on both sides are symmetrically distributed with the vertical central axis of the narrow-faced copper plate 100 as the symmetry line.

As shown in FIG. 2, the upper opening side working face 2 has four sides, including an outer edge of the upper opening side working face, a first connecting line L₁, a lower edge of the upper opening side working face and an upper edge of the upper opening side working face. The lower edge of the upper opening side working face is the intersection line of the lower opening side working face 3 and the upper opening side working face 2, the upper edge of the upper opening side working face is the intersection line of the upper opening side working face 2 and the upper opening 4 of the narrow-faced copper plate, and the outer edge of the upper opening side working face is the edge parallel to and opposite to the first connecting line L₁. The distance between the outer edge of the upper opening side working face and the first connecting line L₁ is a fourth length l₄, which is 30 mm.

The lower opening side working face 3 has four sides, including an outer edge L₂ of the lower opening side working face, the first connecting line L₁, a lower edge of the lower opening side working face and an upper edge of the lower opening side working face. The lower edge of the lower opening side working face is the intersection line of the lower opening side working face 3 and the lower opening 5 of the narrow-faced copper plate, and the upper edge of the lower opening side working face is the intersection line of the lower opening side working face 3 and the upper opening side working face 2. The distance between the outer edge L₂ of the lower opening side working face and the first connecting line L₁ is a fourth length l₄, which is 30 mm.

The outer edge L₂ of the lower opening side working face and the outer edge L₂ of the upper opening side working face meet at the first end O₁.

As shown in FIG. 2, the upper opening side working face 2 has a planar structure, and the distance between the upper opening side working face 2 and the side plane of the cooling surface 6 is the third length l₃, which is 40 mm. In the height direction of the narrow-faced copper plate 100, the height of the upper opening side working face 2 extending from the upper opening 4 of the narrow-faced copper plate to the lower working face 3 is the second length l₂, which is 450 mm.

As shown in FIG. 2 and FIG. 3, the narrow-faced copper plate 100 includes a cooling surface 6, which is arranged opposite to the working face, and a cooling channel is arranged on the cooling surface 6 for cooling the continuous casting slab 300. The cooling surface 6 includes a side plane which is opposite to the second working face and parallel to the upper opening side working face 2. The lower opening side working face 3 includes a first vertex O₂, which is located on the connecting line between the lower opening side working face 3 and the lower opening 5 of the narrow-faced copper plate, and is located away from the first connecting line L₁. The vertical distance between the first vertex O₂ and the side plane is the shortest vertical distance between the lower opening side working face 3 and the side plane. It can be understood that the first vertex O₂ is the intersection of the lower edge of the lower opening side working face and the outer edge L₂ of the lower opening side working face. The vertical distance between the first vertex O₂ and the side plane is the seventh length l₇, the vertical distance between the upper opening side working face 2 and the side plane is the third length l₃, and the length difference between the third length l₃ and the seventh length l₇ is the eighth length l₈. In this embodiment, the third length l₃ is 40 mm, and the eighth length l₈ is 0.5 mm.

The lower opening side working face 3 gradually inclines away from an extending face of the upper opening side working face 2 along a direction from the first connecting line L₁ to the outer edge L₂ of the lower opening side working face, and at the same time, the lower opening side working face 3 gradually inclines away from the extending face of the upper opening side working face 2 along the direction from the upper edge of the lower opening side working face to the lower edge of the lower opening working face.

The first working face 1 is a convex cambered surface, protruding towards the inner cavity of the crystallizer, and the two second working faces are located on both sides of the first working face 1, which are symmetrically arranged along the vertical central axis of the first working face 1. It can be understood that the vertical central axis of the two narrow-faced copper plates 100 are coplanar. The first connecting line L₁ is formed at the joint of the first working face 1 and the second working face, and two first connecting lines L₁ are formed between the two second working faces and the first working face 1. The height of the first working face 1 protruding relative to the plane where the two first connecting lines L₁ are located gradually decreases from the upper opening 4 of the narrow-faced copper plate to the lower opening 5 of the narrow-faced copper plate. The maximum vertical distance between the first working face 1 in the plane where the upper opening 4 of the narrow-faced copper plate is located and the plane where the two first connecting lines L₁ are located is the first length l₁ of the upper opening, which is 12 mm, and the difference between the first length l₁ of the upper opening and the first length of the lower opening is 0.5 mm.

As shown in FIG. 5, in an embodiment, the cooling surface 6 includes two side planes and an arc-shaped surface in a middle part. As shown in FIG. 6, in another embodiment, the cooling surface 6 includes two side planes and a middle surface. This embodiment focuses on the cooling surface 6 with a planar structure as shown in FIG. 6. Three rows of fastening holes 7 are distributed in the width direction of the cooling surface 6 for fixing the narrow-faced copper plate 100 to the stainless steel back plate of the crystallizer. In the width direction of the narrow-faced copper plate 100, the first cooling channel 8 and the second cooling channel 9 with the same width and perpendicular to the plane of the two first connecting lines L₁ are evenly distributed between any two rows of fastening holes 7. The two sides of the cooling surface 6 are respectively provided with inclined channels 10, which are inclined to the middle part of the second working face, and the included angle between the axis of the inclined channel 10 and the upper opening side working face 2 is 01, which is 75 degrees, as shown in FIG. 5.

The first cooling channel 8, the second cooling channel 9 and the inclined channel 10 all have a bottom portion 11, and the bottom portion 11 has a semicircular structure. The cross section of the first working face 1 in the plane where the upper opening side working face 2 meets the lower opening side working face 3 is a reference convex arc L₃, and the cross section of the bottom portion of the plurality of second cooling channels 9 on the same arc surface is the convex arc L₄ arranged in parallel with the reference convex arc L₃. The convex arc L₄ of the cross section of the circular arc surface where the bottom portions 11 of the plurality of second cooling channels 9 are located and the reference convex arc L₃ are arranged in parallel to each other. The convex arc L₄ of the cross section of the circular surface where the groove bottoms 11 of the plurality of second cooling channels 9 are located is obtained by translating 20 mm perpendicular to the cooling surface 6 with reference to the convex arc L₃.

The vertical distance between the bottom portion of the second cooling channel 9 and the bottom portion of the first cooling channel 8 adjacent thereto is the ninth length l₉, which is 1.5 mm in this embodiment, as shown in FIG. 6, thus ensuring the uniform heat transfer of the copper plate of the crystallizer in the width direction.

A crystallizer is further provided in this embodiment, which adopts the convex cambered narrow-faced copper plate 100 of the continuous casting crystallizer as described above. When two narrow-faced copper plates 100 are provided, the distance between the upper openings 4 of the two narrow-faced copper plates 100 is greater than the distance between the lower openings 5 of the two narrow-faced copper plates 100, so that the crystallizer has a structure of a wide upper portion and a narrow lower portion, with a certain reverse tape arranged from 1.05% to 1.35%.

A method for using the convex cambered narrow-faced copper plate 100 of the continuous casting crystallizer is further provided in this embodiment. During the operation of the crystallizer, cooling water is introduced into the cooling channel of the narrow-faced copper plate 100. The amount of the cooling water of the narrow-faced copper plate 100 may be varied based on the structure of the channel. The flow rate of the cooling water in the cooling channel of the narrow-faced copper plate 100 is greater than or equal to 6 m/s, and the temperature difference between the inlet and outlet of the cooling channel of the narrow-faced copper plate 100 is ranged from 5 degrees to 9 degrees.

In this application, the terms “first” and “second” are used for descriptive purposes only and cannot be understood as indicating or implying relative importance. The term “a plurality of” refers to two or more, unless otherwise explicitly defined.

Other embodiments of the present application will be readily apparent to those skilled in the art after considering the specification and practicing the present application disclosed herein. The present application is intended to cover any variations, use or adaptive change of the present application, which follow the general principles of the present application and include common general knowledge or common technical means in the art that are not disclosed in the present application. The specification and examples are to be regarded as exemplary only.

The above is only the preferred embodiment of the present application, and it is not used to limit the present application. Any modification, equivalent substitution, improvement, etc. made within the spirit and principle of the present application should be included in the protection scope of the present application.

What is claimed is:

1. A convex cambered narrow-faced copper plate of a continuous casting crystallizer, comprising a working face, wherein the working face comprises:
a first working face and a second working face;
wherein two second working faces are provided, one of which is arranged at one side of the first working face and the other of which is arranged at the other side of the first working face, and the two second working faces are arranged oppositely;
the first working face is connected to each of the two second working faces, with a first connecting line being provided at a joint of the first working face and the second working face, and two first connecting lines being provided; and
a cross section of the first working face is a convex arc, and the first working face extends from an upper opening of the narrow-faced copper plate to a lower opening of the narrow-faced copper plate, and a height of the first working face protruding relative to a plane where the two first connecting lines are located gradually decreases from the upper opening of the narrow-faced copper plate to the lower opening of the narrow-faced copper plate.

2. The convex cambered narrow-faced copper plate of a continuous casting crystallizer according to claim 1, wherein
a plane where the upper opening of the narrow-faced copper plate is located is parallel to a plane where the lower opening of the narrow-faced copper plate is located;
a maximum vertical distance between the first working face in the plane where the upper opening of the narrow-faced copper plate is located and the plane where the two first connecting lines are located is a first length of the upper opening;
a maximum vertical distance between the first working face in the plane where the lower opening of the narrow-faced copper plate is located and the plane where the two first connecting lines are located is a first length of the lower opening; and
a vertical distance between the plane where the upper opening of the narrow-faced copper plate is located and the plane where the lower opening of the narrow-faced copper plate is located is ranged from 780 mm to 1200 mm, and a difference between the first length of the upper opening and the first length of the lower opening is from 0.2 mm to 4 mm.

3. The convex cambered narrow-faced copper plate of a continuous casting crystallizer according to claim 2, wherein
a width of the upper opening of the narrow-faced copper plate is greater than a width of the lower opening of the narrow-faced copper plate.

4. The convex cambered narrow-faced copper plate of a continuous casting crystallizer according to claim 1, wherein
the second working face extends from the upper opening of the narrow-faced copper plate to the lower opening of the narrow-faced copper plate, and a distance between an outer edge of the second working face and the first connecting line remains unchanged from the upper opening of the narrow-faced copper plate to the lower opening of the narrow-faced copper plate.

5. The convex cambered narrow-faced copper plate of a continuous casting crystallizer according to claim 1, wherein
the second working face comprises an upper opening side working face and a lower opening side working face;
the upper opening side working face is connected to the lower opening side working face, and the upper opening side working face and the lower opening side working face are sequentially arranged along a direction from the upper opening of the narrow-faced copper plate to the lower opening of the narrow-faced copper plate; and
the upper opening side working face is a flat surface, the lower opening side working face is an inclined surface, and the lower opening side working face is inclined in a direction opposite to a convex direction of the first working face.

6. The convex cambered narrow-faced copper plate of a continuous casting crystallizer according to claim 5, wherein
the narrow-faced copper plate comprises a cooling surface, and the cooling surface comprises a side plane which is arranged opposite to the second working face and is arranged in parallel to the upper opening side working face;
the lower opening side working face comprises a first vertex, which is located on a connecting line between the lower opening side working face and the lower opening of the narrow-faced copper plate, and is arranged away from the first connecting line; and
the vertical distance between the first vertex and the side plane is the shortest vertical distance between the lower opening side working face and the side plane.

7. The convex cambered narrow-faced copper plate of a continuous casting crystallizer according to claim 5, wherein
a distance of the upper opening side working face extending from the upper opening of the narrow-faced copper plate to the lower opening side working face is a second length; and
the second length accounts for 25% to 75% of the vertical distance between the plane where the upper opening of the narrow-faced copper plate is located and the plane where the lower opening of the narrow-faced copper plate is located.

8. The convex cambered narrow-faced copper plate of a continuous casting crystallizer according to claim 1, wherein
the narrow-faced copper plate comprises a fastening hole, a first cooling channel and a second cooling channel;
the fastening holes are provided with a plurality of rows, and the plurality of rows of fastening holes are symmetrically arranged along a vertical central axis of the narrow-faced copper plate;
the first cooling channel and the second cooling channel are arranged between two adjacent rows of fastening holes, where two first cooling channels and a plurality of second cooling channels are provided, the two first cooling channels are arranged adjacent to the two rows of fastening holes respectively, and the plurality of second cooling channels are located between the two first cooling channels;
a bottom portion of the first cooling channel is closer to the first working face than a bottom portion of the adjacent second cooling channel; and
the bottom portions of the plurality of second cooling channels are located on a same arc surface.

9. The convex cambered narrow-faced copper plate of a continuous casting crystallizer according to claim 8, wherein
a cross section of the first working face in a plane where the upper opening side working face and the lower opening side working face intersect with each other is a reference convex arc; and
a convex arc of a cross section of a circular arc surface where the bottom portions of the plurality of second cooling channels are located are arranged in parallel to the reference convex arc.

10. A method for using a convex cambered narrow-faced copper plate of a continuous casting crystallizer, wherein the convex cambered narrow-faced copper plate of a continuous casting crystallizer according to claim 1 is adopted to form the crystallizer; and
in a working process of the crystallizer, cooling water is introduced into the cooling channel of the narrow-faced copper plate, flow rate of the cooling water in the cooling channel of the narrow-faced copper plate is greater than or equal to 6 m/s, and temperature difference between an inlet and an outlet of the cooling channel of the narrow-faced copper plate ranges from 5 degrees to 9 degrees.
